(19) United States
(12) Patent Application Publication
(10) Pub. No.: US 2023/0059180 A1
(43) Pub. Date: Feb. 23, 2023

(54) COMMUNICATION SYSTEM, COMMUNICATION CONTROL METHOD, AND NON-TRANSITORY RECORDING MEDIUM

(71) Applicants: Natsumi Fujimura, Kanagawa (JP); Hiroshi Ota, Tokyo (JP)

(72) Inventors: Natsumi Fujimura, Kanagawa (JP); Hiroshi Ota, Tokyo (JP)

(73) Assignee: Ricoh Company, Ltd., Tokyo (JP)

(21) Appl. No.: 17/818,787

(22) Filed: Aug. 10, 2022

(30) Foreign Application Priority Data
Aug. 23, 2021 (JP) 2021-135687

(51) Int. Cl. H04W 12/06; H04W 76/10

(52) U.S. Cl. CPC H04W 12/06; H04W 76/10

(57) ABSTRACT

A communication system includes a user terminal, and a communication server. The user terminal includes first circuitry that requests the communication server to perform authentication, and transmits identification information for identifying the user terminal to the communication server to request the communication server to establish a connection, the identification information being issued by the communication server in response to the user terminal having been successfully authenticated. The communication server includes second circuitry that issues the identification information in response to a result of the authentication indicating successful authentication, and determines whether to permit a connection to the user terminal, based on the identification information received from the user terminal.

### CROSS-REFERENCE TO RELATED APPLICATIONS

This patent application is based on and claims priority pursuant to 35 U.S.C. § 119(a) to Japanese Patent Application No. 2021-135687, filed on Aug. 23, 2021, in the Japan Patent Office, the entire disclosure of which is hereby incorporated by reference herein.

### BACKGROUND

### Technical Field

The present disclosure relates to a communication system, a communication control method, and a non-transitory recording medium.

### Description of the Related Art

Web applications may use authentication using user IDs and passwords, as well as multi-factor authentication using different factors.

For example, an authentication system performs first authentication using a certificate and second authentication using a user ID and a password.

In such an authentication system, a certificate is issued in response to a request from a client terminal, and any user can acquire a certificate at any terminal.

### SUMMARY

A communication system according to an aspect of the present disclosure includes a user terminal, and a communication server. The user terminal includes first circuitry that requests the communication server to perform authentication and transmits identification information for identifying the user terminal to the communication server to request the communication server to establish a connection. The identification information is issued by the communication server in response to the user terminal having been successfully authenticated. The communication server includes second circuitry that issues the identification information in response to a result of the authentication indicating successful authentication and determines whether to permit a connection to the user terminal, based on the identification information received from the user terminal.

A communication system according to an aspect of the present disclosure includes a user terminal, a relay device including circuitry that makes a determination as to whether communication between the relay device and the user terminal is permitted, and a communication server. The user terminal includes circuitry that requests the communication server to issue a certificate and transmits the certificate to the communication server to request the communication server to establish a connection. The certificate is issued by the communication server in response to a determination being made that communication between the relay device and the user terminal is permitted. The communication server includes circuitry that issues the certificate in accordance with a result of the determination made by the circuitry of the relay device and determines whether to permit the connection, based on the certificate received from the user terminal.

A communication control method according to an aspect of the present disclosure includes obtaining an authentication result in response to a request from a user terminal; issuing identification information for identifying the user terminal in response to the authentication result indicating successful authentication; and determining whether to permit a connection to the user terminal, based on the identification information received from the user terminal.

A non-transitory recording medium according to an aspect of the present disclosure stores a plurality of instructions which, when executed by one or more processors, cause the processors to perform a communication control method including obtaining an authentication result in response to a request from a user terminal; issuing identification information for identifying the user terminal in response to the authentication result indicating successful authentication; and determining whether to permit a connection to the user terminal, based on the identification information received from the user terminal.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example general arrangement of a communication system according to a first embodiment of the disclosure;

FIG. 2 is a diagram illustrating an example hardware configuration of a computer according to an embodiment of the disclosure;

FIG. 3 is a diagram illustrating an example functional configuration of the communication system according to the first embodiment of the disclosure;

FIG. 4 is a diagram illustrating an example procedure of a communication method according to the first embodiment of the disclosure;

FIG. 5 is a diagram illustrating an example general arrangement of a communication system according to a second embodiment of the disclosure;

FIG. 6 is a diagram illustrating an example functional configuration of the communication system according to the second embodiment of the disclosure;

FIG. 7 is a diagram illustrating an example procedure of a communication method according to the second embodiment of the disclosure;

FIG. 8 is a table illustrating an example of hardware unique information according to the second embodiment of the disclosure;

FIG. 9 is an example of a connection permission determination table according to the second embodiment of the disclosure;

FIG. 10 is a diagram illustrating an example general arrangement of a communication system according to a third embodiment of the disclosure;

FIG. 11 is a diagram illustrating an example functional configuration of the communication system according to the third embodiment of the disclosure;

FIG. 12 is a diagram illustrating an example procedure of a communication method according to the third embodiment of the disclosure;

FIG. 13 is a diagram illustrating an example general arrangement of a communication system according to a fourth embodiment of the disclosure;

FIG. 14 is a diagram illustrating an example functional configuration of the communication system according to the fourth embodiment of the disclosure; and

FIG. 15 is a diagram illustrating an example procedure of a communication method according to the fourth embodiment of the disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a,” “an,” and “the” are intended to include the plural forms as well, unless the context clearly indicates otherwise.

Embodiments of the present disclosure will be described in detail hereinafter with reference to the drawings. In the drawings, components having substantially the same functions are denoted by the same reference numerals, and will not be repeatedly described.

### First Embodiment

A first embodiment of the present disclosure provides a communication system in which a communication server provides a remote desktop connection to a user terminal. The communication system according to the first embodiment permits the remote desktop connection to, for example, only a user terminal that has been successfully authenticated using a user ID and a password and that satisfies a predetermined condition. In one example, but not by way of limitation, the predetermined condition is that a user terminal attempting to establish a remote desktop connection from an external network has previously made a remote desktop connection via an office network. The communication system according to the first embodiment may use any condition that can be defined for a user terminal.

To implement the above operation, the communication server according to the first embodiment issues identification information that uniquely identifies a user terminal after the user terminal is successfully authenticated for the first time. The identification information is hereinafter referred to as “browser ID”. The user terminal transmits the browser ID issued by the communication server when sending a request to the communication server to establish a remote desktop connection. The communication server determines, based on the browser ID received from the user terminal, whether the user terminal satisfies the predetermined condition, and permits the remote desktop connection only upon satisfaction of the predetermined condition.

While providing a remote desktop connection by way of example, the communication system according to the first embodiment is capable of providing any connection for session management. Also in the following embodiments, the communication system may be configured to provide any connection.

### General Arrangement of Communication System According to First Embodiment

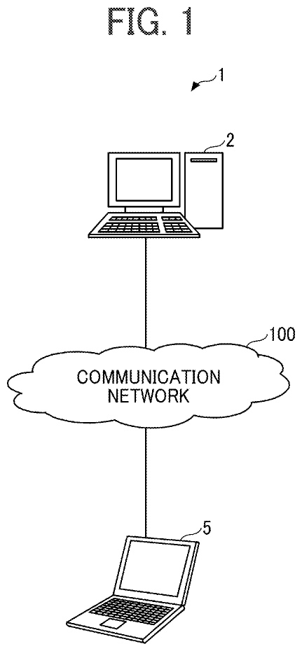

FIG. 1 is a diagram illustrating an example general arrangement of a communication system 1 according to the first embodiment of the present disclosure.

As illustrated in FIG. 1, the communication system 1 according to the first embodiment includes a communication server 2 and a user terminal 5, for example.

The communication server 2 and the user terminal 5 are connected to a communication network 100.

The communication network 100 is configured to provide mutual communication between devices connected to the communication network 100. The communication network 100 includes the Internet, a local area network (LAN), a wide area network (WAN), or any other wired communication network, for example. The communication network 100 includes not only a wired communication network but also a wireless or mobile communication network such as a third generation (3G), Worldwide Interoperability for Microwave Access (WiMAX), or Long Term Evolution (LTE) network.

The communication server 2 and the user terminal 5 are computers, for example. The communication server 2 and the user terminal 5 are not limited to computers and may be any apparatuses having a communication function. Examples of the communication server 2 and the user terminal 5 include, but are not limited to, an output device such as a projector (PJ), an interactive whiteboard (IWB), which is an electronic whiteboard having mutual communication capability, and a digital signage, a head-up display (HUD) device, an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC, and a desktop PC.

### Hardware Configuration of Communication System According to First Embodiment Hardware Configuration of Computer

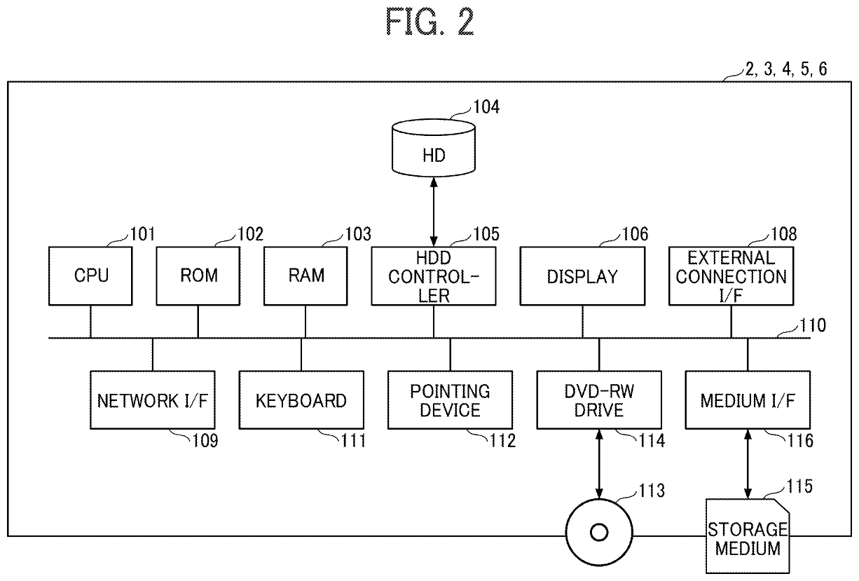

FIG. 2 is a hardware configuration diagram of the communication server 2 and the user terminal 5, each of which is a computer. As illustrated in FIG. 2, the communication server 2 and the user terminal 5 each include a central processing unit (CPU) 101, a read only memory (ROM) 102, a random access memory (RAM) 103, a hard disk (HD) 104, a hard disk drive (HDD) controller 105, a display 106, an external device connection interface (I/F) 108, a network I/F 109, a bus line 110, a keyboard 111, a pointing device 112, a digital versatile disc rewritable (DVD-RW) drive 114, and a medium I/F 116.

The CPU 101 controls the overall operation of the communication server 2 and the user terminal 5. The ROM 102 stores a control program such as an initial program loader (IPL) to boot the CPU 101.

The RAM 103 is used as a work area for the CPU 101. The HD 104 stores various data such as a program. The HDD controller 105 controls reading or writing of various data from or to the HD 104 under the control of the CPU 101. The display 106 displays various kinds of information such as a cursor, a menu, a window, characters, or an image. The external device connection I/F 108 is an interface for connecting to various external devices. The external devices include, for example, but are not limited to, a universal serial bus (USB) memory and a printer. The network I/F 109 is an interface that controls communication of data with an external device through the communication network 100. The bus line 110 is, for example, an address bus or a data bus, which electrically connects the elements illustrated in FIG. 2, such as the CPU 101, to each other.

The keyboard 111 is an example of an input device provided with a plurality of keys for allowing a user to input characters, numerals, or various instructions. The pointing device 112 is an example of an input device that allows a user to select or execute a specific instruction, select a target for processing, or move a cursor being displayed. The DVD-RW drive 114 controls reading or writing of various data from or to a DVD-RW 113, which is an example of a removable recording medium. The removable recording medium is not limited to a DVD-RW and may be a digital versatile disc recordable (DVD-R), for example. The medium I/F 116 controls reading or writing of data from or to a recording medium 115 such as a flash memory.

### Functional Configuration of Communication System According to First Embodiment

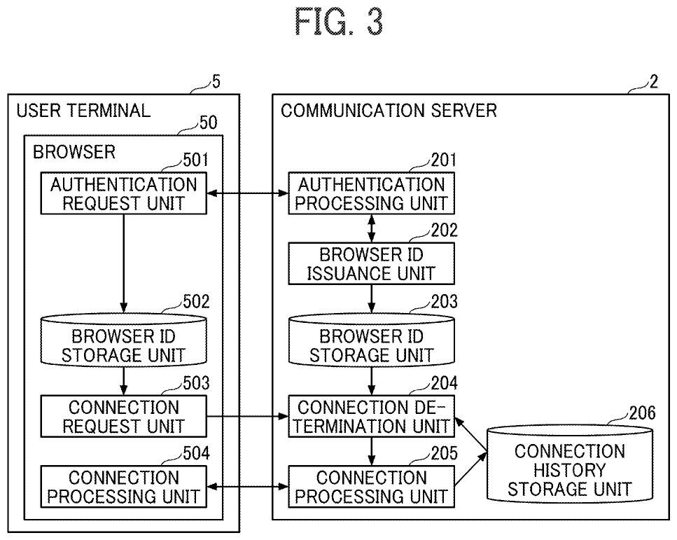

FIG. 3 is a diagram illustrating an example functional configuration of the communication system 1 according to the first embodiment.

### Functional Configuration of Communication Server

As illustrated in FIG. 3, the communication server 2 according to the first embodiment includes an authentication processing unit 201, a browser ID issuance unit 202, a browser ID storage unit 203, a connection determination unit 204, a connection processing unit 205, and a connection history storage unit 206.

The components of the communication server 2, except for the storage units, are functions implemented or means caused to function in response to the CPU 101 illustrated in FIG. 2 executing various instructions on data read into the RAM 103 in accordance with a program loaded onto the RAM 103 from the HD 104. The storage units included in the communication server 2 are functions implemented or means caused to function in response to data being read or written from or to the HD 104 through the HDD controller 105 illustrated in FIG. 2.

The authentication processing unit 201 receives a signal for requesting authentication from the user terminal 5. The signal is hereinafter referred to as “authentication request signal”. The authentication processing unit 201 authenticates the user terminal 5 using authentication information included in the authentication request signal and obtains an authentication result. The authentication processing unit 201 transmits the authentication result to the user terminal 5.

The browser ID issuance unit 202 issues a browser ID that uniquely identifies the user terminal 5 after the user terminal 5 is successfully authenticated. The browser ID issuance unit 202 transmits the issued browser ID to the user terminal 5.

The browser ID storage unit 203 stores the browser ID issued to the user terminal 5 in association with user information related to the user of the user terminal 5.

The connection determination unit 204 receives a signal for requesting a connection from the user terminal 5. The signal is hereinafter referred to as “connection request signal”. The connection determination unit 204 determines whether to permit a connection to the user terminal 5, based on the browser ID included in the connection request signal.

The connection processing unit 205 establishes a connection to the user terminal 5 when the determination result based on the browser ID, which is output from the connection determination unit 204, indicates permission of the connection to the user terminal 5.

The connection history storage unit 206 stores a connection history. The connection history includes a record of a connection made to the user terminal 5.

### Functional Configuration of User Terminal

As illustrated in FIG. 3, the user terminal 5 according to the first embodiment includes a browser 50. The browser 50 includes an authentication request unit 501, a browser ID storage unit 502, a connection request unit 503, and a connection processing unit 504.

The components of the user terminal 5, except for the storage unit, are functions implemented or means caused to function in response to the CPU 101 illustrated in FIG. 2 executing various instructions on data read into the RAM 103 in accordance with a program loaded onto the RAM 103 from the HD 104. The storage unit included in the user terminal 5 is a function implemented or a means caused to function in response to data being read or written from or to the HD 104 through the HDD controller 105 illustrated in FIG. 2.

The authentication request unit 501 transmits an authentication request signal to the communication server 2 in accordance with an operation performed by the user of the user terminal 5. The authentication request signal includes authentication information. A browser ID issued to the user terminal 5 by the communication server 2 is included in the authentication request signal.

The browser ID storage unit 502 stores the browser ID issued by the communication server 2 to the user terminal 5.

The connection request unit 503 transmits a connection request signal to the communication server 2 in accordance with an operation performed by the user of the user terminal 5. The connection request signal includes connection information and the browser ID stored in the browser ID storage unit 502.

The connection processing unit 504 connects to the communication server 2 and communicates with the connection processing unit 205 of the communication server 2. Processing Procedure of Communication System according to First Embodiment

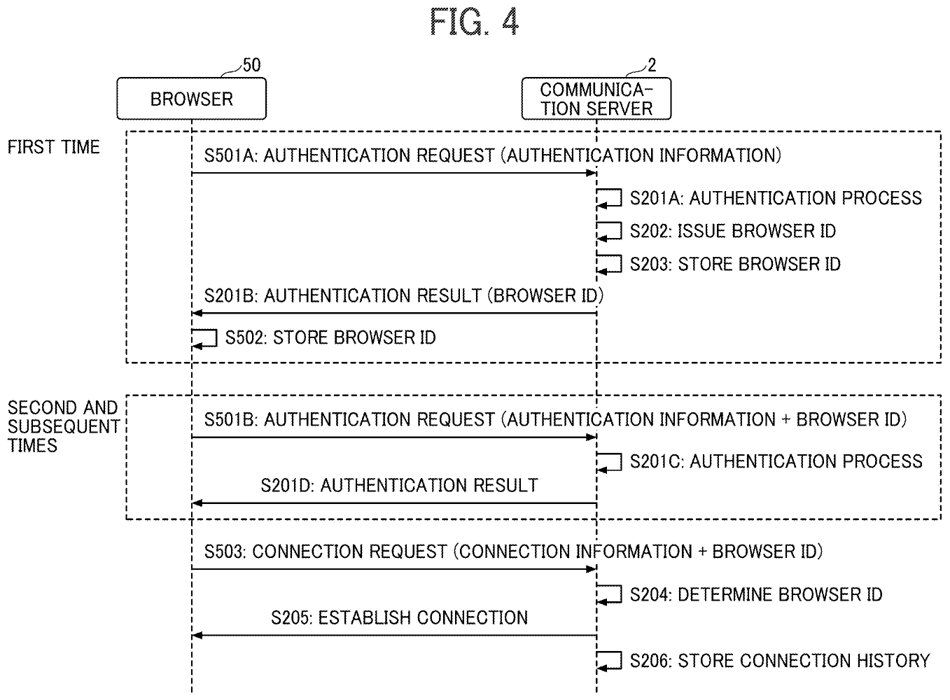

FIG. 4 is a diagram illustrating an example procedure of a communication method executed by the communication system 1 according to the first embodiment.

In FIG. 4, steps S501A to S502 are executed to send an authentication request from the user terminal 5 to the communication server 2 for the first time.

In step S501A, the authentication request unit 501 of the browser 50 transmits an authentication request signal including authentication information to the communication server 2 in accordance with an operation performed by the user of the user terminal 5. The authentication request signal is transmitted in response to the browser 50 issuing a request for a uniform resource locator (URL) for performing authentication. The authentication information includes a user ID and a password, which are entered by the user on a login screen, for example. The authentication request signal may include user information related to the user. The user information includes a user ID, which is entered by the user on the login screen, for example. When the authentication information corresponds to the user information, the authentication request signal may include only the authentication information.

In step S201A, the authentication processing unit 201 of the communication server 2 receives the authentication request signal from the user terminal 5. The authentication processing unit 201 authenticates the user terminal 5 using the authentication information included in the authentication request signal and obtains an authentication result. The authentication processing unit 201 determines whether the received authentication information matches authentication information registered in advance to obtain an authentication result. The authentication processing unit 201 may transfer the received authentication information to an external authentication server to obtain an authentication result from the authentication server.

In step S202, the browser ID issuance unit 202 of the communication server 2 determines whether to issue a browser ID to the user terminal 5 after the user terminal 5 is successfully authenticated. The determination of whether to issue a browser ID may be performed by, for example, determining whether a browser ID has been issued to the user terminal 5. The determination of whether a browser ID has been issued to the user terminal 5 may be performed by, for example, determining whether the authentication request signal received from the user terminal 5 includes a browser ID. In this procedure, the authentication request signal includes no browser ID, and the browser ID issuance unit 202 issues a browser ID that uniquely identifies the user terminal 5.

In one example, the browser ID issuance unit 202 issues a browser ID such that the user information included in the connection request signal and the browser ID are associated with each other on a one-to-one basis. In this example, if the browser ID storage unit 203 includes the browser ID associated with the user information included in the authentication request signal, the browser ID issuance unit 202 does not issue a new browser ID. Alternatively, the browser ID issuance unit 202 discards the browser ID associated with the user information, issues a new browser ID, and associates the new browser ID with the user information. Associating user information and browser IDs with each other on a one-to-one basis may limit the number of terminals that a single user is allowed to use to establish a connection to one.

In step S203, the browser ID issuance unit 202 of the communication server 2 stores the browser ID issued to the user terminal 5 in the browser ID storage unit 203. At this time, the user information included in the authentication request signal and the browser ID may be stored in association with each other.

In step S201B, the authentication processing unit 201 of the communication server 2 transmits the obtained authentication result to the user terminal 5 together with the browser ID issued by the browser ID issuance unit 202. For example, if the authentication result indicates successful authentication, the authentication processing unit 201 transmits a post-login screen that transitions from the login screen to the user terminal 5. The post-login screen that is transmitted includes the browser ID. The browser ID is information unknown to the user and is included in the post-login screen as a hidden element, in one example. If the authentication result indicates authentication failure, the authentication processing unit 201 transmits an error screen indicating that the authentication has failed to the user terminal 5.

In step S502, the authentication request unit 501 of the browser 50 receives the browser ID together with the authentication result from the communication server 2. The authentication request unit 501 stores the received browser ID in the browser ID storage unit 502. A known method for storing information in a browser, such as Cookie or Web Storage (local storage or session storage), may be used.

In FIG. 4, steps S501B to S201D are executed to send an authentication request from the user terminal 5 to the communication server 2 for the second and subsequent times.

In step S501B, the authentication request unit 501 of the browser 50 transmits an authentication request signal to the communication server 2 in accordance with an operation performed by the user of the user terminal 5. The authentication request signal includes the authentication information and the browser ID stored in the browser ID storage unit 502.

In step S201C, the authentication processing unit 201 of the communication server 2 receives the authentication request signal from the user terminal 5. The authentication processing unit 201 authenticates the user terminal 5 using the authentication information included in the authentication request signal and obtains an authentication result.

Since the authentication request signal received from the user terminal 5 includes the browser ID, the browser ID issuance unit 202 determines that the browser ID is not to be issued.

In step S201D, the authentication processing unit 201 of the communication server 2 transmits the obtained authentication result to the user terminal 5. For example, if the authentication result indicates successful authentication, the authentication processing unit 201 transmits a post-login screen that transitions from the login screen to the user terminal 5. Since no browser ID is issued, the post-login screen includes no browser ID.

If the authentication result indicates authentication failure, the authentication processing unit 201 transmits an error screen indicating that the authentication has failed to the user terminal 5.

In FIG. 4, steps S503 to S206 are performed to send a request for a remote desktop connection from the user terminal 5 to the communication server 2.

In step S503, the connection request unit 503 of the browser 50 transmits a connection request signal to the communication server 2 in accordance with an operation performed by the user of the user terminal 5. The connection request signal includes connection information and the browser ID stored in the browser ID storage unit 502. The connection request signal is transmitted in response to the browser 50 issuing a request for a URL for establishing a remote desktop connection. The connection information includes, for example, a user ID and a password for the remote desktop connection, which are entered by the user on a login screen for the remote desktop connection. In one example, the browser ID is provided, as a query parameter, in a URL for establishing a remote desktop connection.

In step S204, the connection determination unit 204 of the communication server 2 receives the connection request signal from the user terminal 5. The connection determination unit 204 determines whether to permit the remote desktop connection to the user terminal 5, based on the browser ID included in the connection request signal. The determination of whether to permit the remote desktop connection to the user terminal 5 is performed by determining whether the user terminal 5 indicated by the browser ID satisfies a predetermined condition. If the user terminal 5 indicated by the browser ID satisfies the predetermined condition, the connection determination unit 204 generates a determination result indicating permission of the remote desktop connection to the user terminal 5. By contrast, if the user terminal 5 indicated by the browser ID does not satisfy the predetermined condition, the connection determination unit 204 generates a determination result indicating rejection of the remote desktop connection to the user terminal 5.

The predetermined condition for the determination made by the connection determination unit 204 is that, for example, a user terminal requesting a remote desktop connection from an external network has previously made a remote desktop connection via an office network. Whether the user terminal 5 is requesting a remote desktop connection from an external may be determined from the network address of the source of the connection request signal, for example. Whether the user terminal 5 has previously made a remote desktop connection via the office network may be determined from the connection history stored in the connection history storage unit 206. It is desirable that the user terminal 5 have made a remote desktop connection via the office network at least once.

In step S205, the connection processing unit 205 of the communication server 2 communicates with the connection processing unit 504 of the user terminal 5 and establishes a remote desktop connection to the user terminal 5 if the connection determination unit 204 permits the remote desktop connection to the user terminal 5. If the connection determination unit 204 rejects the remote desktop connection to the user terminal 5, the connection processing unit 205 transmits an error screen indicating rejection of the remote desktop connection to the user terminal 5.

In step S206, the connection processing unit 205 of the communication server 2 stores in the connection history storage unit 206 a connection history including a record of a remote desktop connection made to the user terminal 5. The connection history includes information indicating the user terminal 5 and information indicating the network from which the remote desktop connection is made.

The communication system according to the first embodiment is configured to determine whether to permit a remote desktop connection to a user terminal, based on a browser ID received from the user terminal. The browser ID is issued when the user terminal is successfully authenticated for the first time, and is not rewritten after being stored in the storage unit in the browser. Accordingly, the browser ID is capable of uniquely identifying the user terminal. Such a browser ID is used to determine whether to permit a remote desktop connection, which enables only an authorized user terminal to establish the remote desktop connection.

The communication system according to the first embodiment may also be configured to issue a browser ID such that user information and the browser ID are associated with each other on a one-to-one basis. This configuration may limit the number of terminals that a single user is allowed to use to establish a connection to one.

### Second Embodiment

The communication system according to the first embodiment issues a browser ID such that a user terminal can be uniquely identified, and determines whether to permit a remote desktop connection, based on the browser ID. A communication system according to a second embodiment determines whether to permit a remote desktop connection, based on a combination of a determination result based on the browser ID and a determination result based on hardware unique information of the user terminal. The hardware unique information is hereinafter also referred to simply as “unique information”.

The following describes a communication system 1 according to the second embodiment of the present disclosure, focusing on the differences from the first embodiment.

### General Arrangement of Communication System According to Second Embodiment

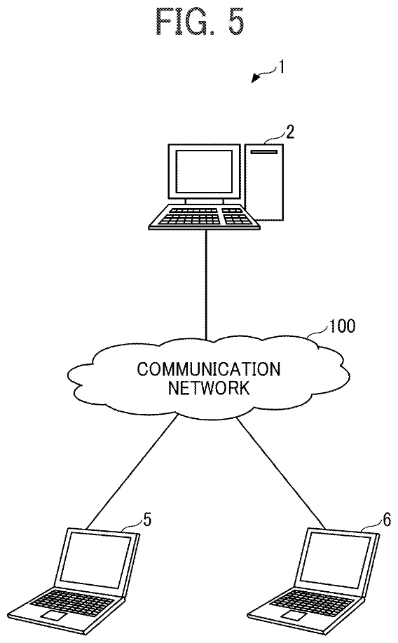

FIG. 5 is a diagram illustrating an example general arrangement of the communication system 1 according to the second embodiment of the present disclosure.

As illustrated in FIG. 5, the communication system 1 according to the second embodiment includes a communication server 2, a user terminal 5, and an administrator terminal 6, for example. The administrator terminal 6 is connected to a communication network 100 and is capable of mutually communicating with the communication server 2 and the user terminal 5.

The administrator terminal 6 is a computer, for example. The administrator terminal 6 is not limited to a computer and may be any apparatus having a communication function. Examples of the administrator terminal 6 include, but are not limited to, an output device such as a projector (PJ), an interactive whiteboard (IWB), which is an electronic whiteboard having mutual communication capability, and a digital signage, a head-up display (HUD) device, an industrial machine, an imaging device, a sound collecting device, a medical device, a networked home appliance, an automobile (connected car), a laptop PC, a mobile phone, a smartphone, a tablet terminal, a game console, a personal digital assistant (PDA), a digital camera, a wearable PC, and a desktop PC.

### Functional Configuration of Communication System According to Second Embodiment

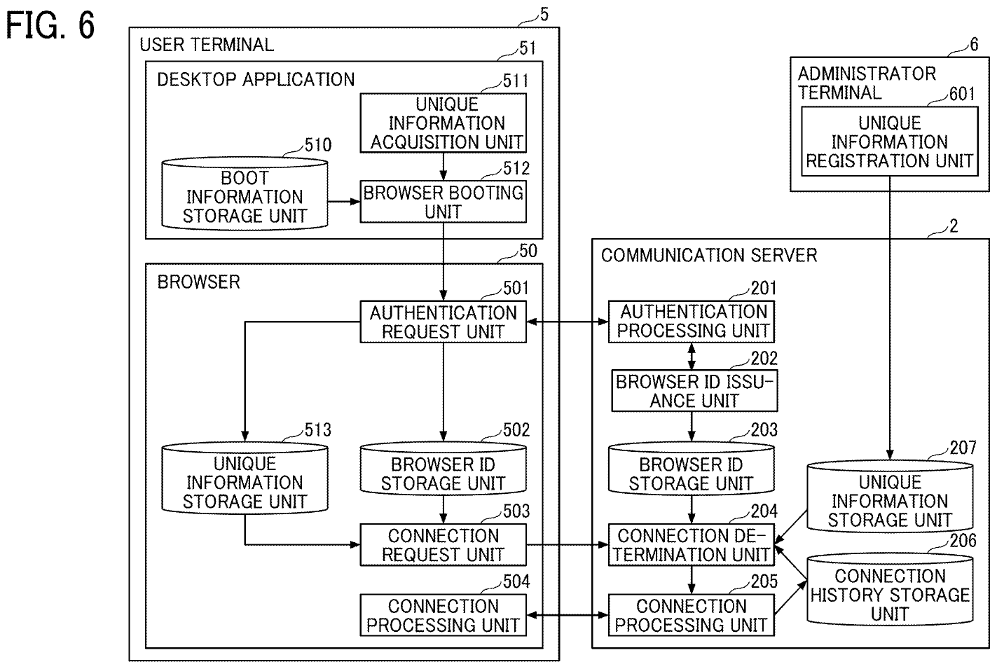

FIG. 6 is a diagram illustrating an example functional configuration of the communication system 1 according to the second embodiment.

### Functional Configuration of Communication Server

As illustrated in FIG. 6, the communication server 2 according to the second embodiment includes an authentication processing unit 201, a browser ID issuance unit 202, a browser ID storage unit 203, a connection determination unit 204, a connection processing unit 205, and a connection history storage unit 206, as in the first embodiment, and further includes a unique information storage unit 207.

The unique information storage unit 207 stores unique information related to the user terminal 5 permitted to establish a remote desktop connection. The unique information related to the user terminal 5, which is stored in the unique information storage unit 207, is registered in advance from the administrator terminal 6.

### Functional Configuration of User Terminal

As illustrated in FIG. 6, the user terminal 5 according to the second embodiment includes a browser 50, as in the first embodiment, and further includes a desktop application 51. The desktop application 51 includes a boot information storage unit 510, a unique information acquisition unit 511, and a browser booting unit 512. The browser 50 according to the second embodiment includes an authentication request unit 501, a browser ID storage unit 502, a connection request unit 503, and a connection processing unit 504, as in the first embodiment, and further includes a unique information storage unit 513.

The boot information storage unit 510 stores boot information for booting the browser 50. The boot information includes a command for booting the browser 50, a URL for acquiring a login screen, and information indicating a query parameter to be provided in the URL, for example.

The unique information acquisition unit 511 acquires unique information related to the user terminal 5 from the hardware of the user terminal 5.

The browser booting unit 512 boots the browser 50 using the boot information stored in the boot information storage unit 510, and passes the unique information related to the user terminal 5, which is acquired by the unique information acquisition unit 511, to the browser 50.

The unique information storage unit 513 stores the unique information related to the user terminal 5, which is passed from the browser booting unit 512 to the browser 50.

### Functional Configuration of Administrator Terminal

As illustrated in FIG. 6, the administrator terminal 6 according to the second embodiment includes a unique information registration unit 601.

The unique information registration unit 601 of the administrator terminal 6 is a function implemented or a means caused to function in response to the CPU 101 illustrated in FIG. 2 executing various instructions on data read into the RAM 103 in accordance with a program loaded onto the RAM 103 from the HD 104.

The unique information registration unit 601 registers unique information related to the user terminal 5 permitted to establish a remote desktop connection in the unique information storage unit 207 of the communication server 2 in advance.

### Processing Procedure of Communication System According to Second Embodiment

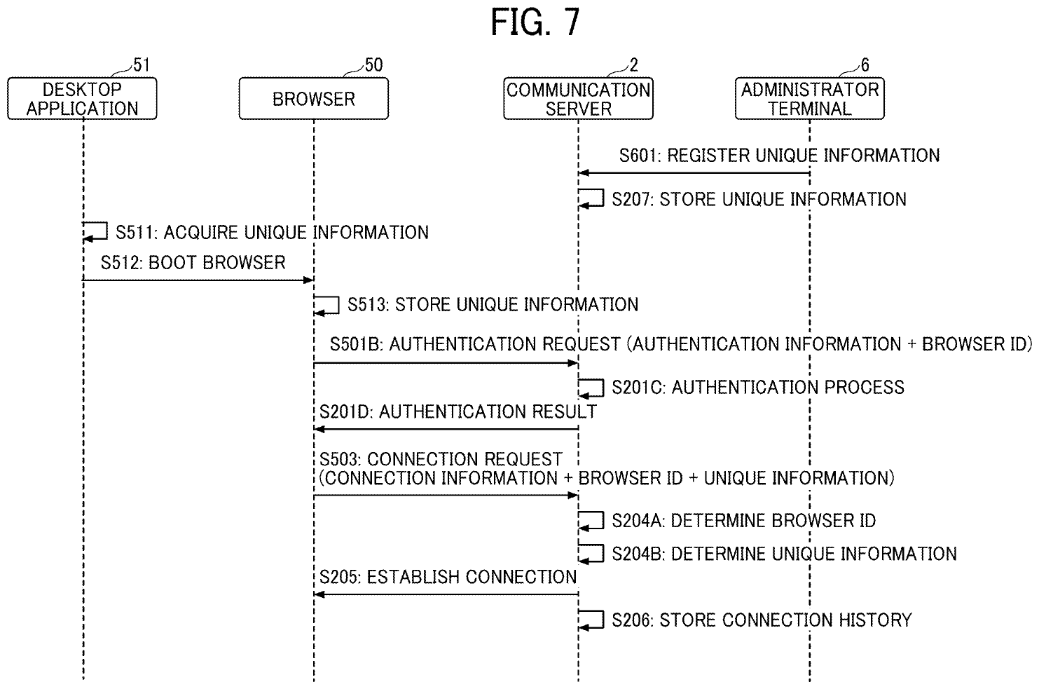

FIG. 7 is a diagram illustrating an example procedure of a communication method executed by the communication system 1 according to the second embodiment. The illustrated procedure is performed to send an authentication request from the user terminal 5 to the communication server 2 for the second and subsequent times. That is, in the illustrated procedure, the communication server 2 has issued a browser ID to the user terminal 5. In the procedure for sending an authentication request from the user terminal 5 to the communication server 2 for the first time (that is, the procedure performed in a case where the communication server 2 has not issued a browser ID to the user terminal 5), steps S501B to S201D illustrated in FIG. 7 are replaced with steps S501A to S502 illustrated in FIG. 4.

In step S601, the unique information registration unit 601 of the administrator terminal 6 transmits unique information related to the user terminal 5 permitted to establish a remote desktop connection to the communication server 2. The unique information may be acquired from the hardware of the user terminal 5 and includes one or more pieces of attribute information. In one example, the user terminal 5 is managed by a device management system. In this case, the unique information registration unit 601 automatically acquires the unique information related to the user terminal 5 from the device management system and transmits only the unique information related to the user terminal 5 selected as the user terminal 5 permitted to establish a remote desktop connection to the communication server 2. In another example, the unique information registration unit 601 inputs the acquired unique information to a predetermined hash function to obtain a hash value, and transmits the hash value to the communication server 2 as the unique information.

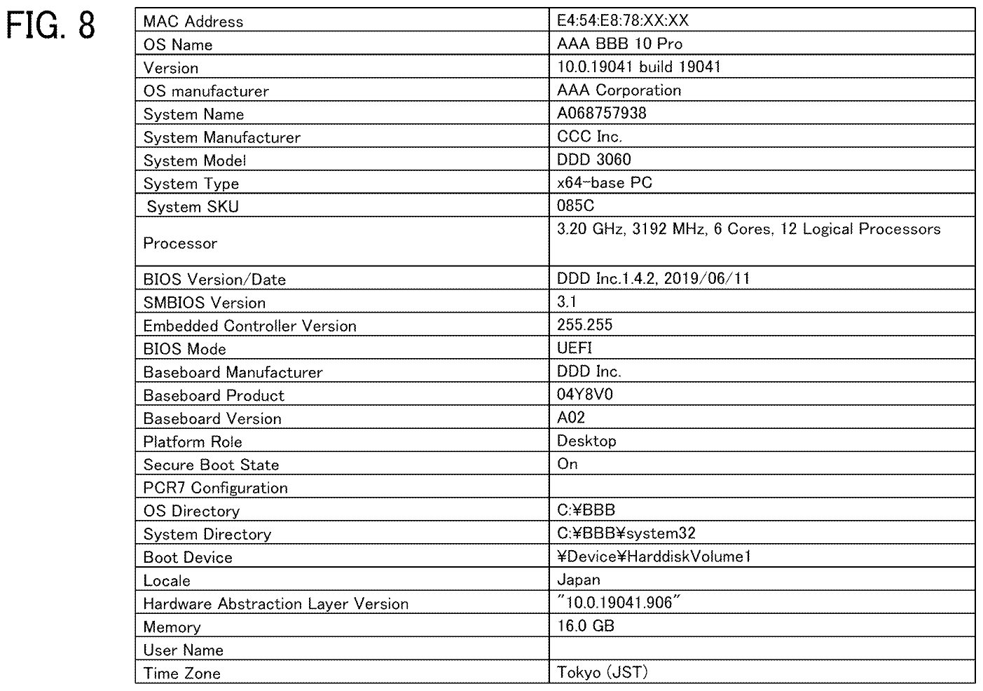

FIG. 8 illustrates an example of the hardware unique information. As illustrated in FIG. 8, the hardware unique information includes, for example, a Media Access Control (MAC) address, an operating system (OS) name, a version, an OS manufacturer, a system name, a system manufacturer, a system model, a system type, a system stock keeping unit (SKU), a processor, a basic input output system (BIOS) version/date, a System Management BIOS (SMBIOS) version, an embedded controller version, a BIOS mode, a baseboard manufacturer, a baseboard product, a baseboard version, a platform role, a secure boot status, a PCR7 configuration, an OS directory, a system directory, a boot device, a locale, a hardware abstraction layer version, a memory, a user name, and a time zone. The illustrated attribute information includes information that is fixed at the time of hardware manufacture and does not fluctuate, and information that fluctuates due to maintenance such as software update. The unique information registration unit 601 acquires, as the unique information, one piece of attribute information or a combination of pieces of attribute information, which are determined in advance, among the pieces of attribute information illustrated in FIG. 8.

Referring back to FIG. 7, the operation will still be described. In step S207, the communication server 2 receives the unique information from the administrator terminal 6. The communication server 2 stores the received unique information in the unique information storage unit 207 in association with information indicating the user terminal 5.

In step S511, the unique information acquisition unit 511 of the desktop application 51 acquires unique information related to the user terminal 5 from the hardware of the user terminal 5. The unique information acquired by the unique information acquisition unit 511 is similar to the unique information registered by the unique information registration unit 601. That is, if the unique information registration unit 601 has registered unique information including a plurality of pieces of attribute information, the unique information acquisition unit 511 acquires unique information including the same pieces of attribute information. If the unique information registration unit 601 has registered the hash value of the unique information, the unique information acquisition unit 511 generates a hash value from the acquired unique information.

In step S512, the browser booting unit 512 of the desktop application 51 boots the browser 50 using the boot information stored in the boot information storage unit 510, and passes the unique information related to the user terminal 5, which is acquired by the unique information acquisition unit 511, to the browser 50. In one example, the browser booting unit 512 provides unique information, as a query parameter, in a URL for acquiring a login screen to pass the unique information to the browser 50.

In step S513, the browser 50 receives the unique information related to the user terminal 5 from the browser booting unit 512, and stores the unique information in the unique information storage unit 513. Like the browser ID storage unit 502, the unique information storage unit 513 stores the information in the browser using a known method.

In step S503, the connection request unit 503 of the browser 50 transmits a connection request signal to the communication server 2. In the second embodiment, the connection request signal further includes the unique information stored in the unique information storage unit 513, in addition to the connection information entered by the user and the browser ID stored in the browser ID storage unit 502.

In step S204A, the connection determination unit 204 of the communication server 2 receives the connection request signal from the user terminal 5. The connection determination unit 204 determines whether to permit the remote desktop connection to the user terminal 5, based on the browser ID included in the connection request signal.

In step S204B, the connection determination unit 204 of the communication server 2 determines whether to permit the remote desktop connection to the user terminal 5, based on the unique information included in the connection request signal. First, the connection determination unit 204 compares the unique information received from the user terminal 5 with the unique information stored in the unique information storage unit 207. If the unique information received from the user terminal 5 and the unique information stored in the unique information storage unit 207 match, the connection determination unit 204 generates a determination result indicating permission of the remote desktop connection to the user terminal 5. By contrast, if the unique information received from the user terminal 5 and the unique information stored in the unique information storage unit 207 do not match, the connection determination unit 204 generates a determination result indicating rejection of the remote desktop connection to the user terminal 5.

In one example, the unique information includes a plurality of pieces of attribute information. In this case, the connection determination unit 204 compares each of the pieces of attribute information included in the unique information received from the user terminal 5 with a corresponding one of the pieces of attribute information included in the unique information stored in the unique information storage unit 207, and determines that the unique information received from the user terminal 5 and the unique information stored in the unique information storage unit 207 match if the number of pieces of attribute information for which a match is found is greater than or equal to a predetermined threshold value. The connection determination unit 204 may determine that the unique information received from the user terminal 5 and the unique information stored in the unique information storage unit 207 match if the ratio of the number of pieces of attribute information for which a match is found to the total number of pieces of attribute information is greater than or equal to a predetermined threshold value. In another example, the unique information is a hash value. In this case, the connection determination unit 204 determines that the unique information received from the user terminal 5 and the unique information stored in the unique information storage unit 207 match if the hash value received from the user terminal 5 and the hash value stored in the unique information storage unit 207 match.

The connection determination unit 204 determines whether to permit the remote desktop connection to the user terminal 5, using the determination result based on the browser ID, which is obtained in step S204A, and the determination result based on the unique information, which is obtained in step S204B. For example, the connection determination unit 204 checks the determination result based on the browser ID and the determination result based on the unique information against a predetermined connection permission determination table to determine whether to permit the connection to the user terminal 5. The connection permission determination table is a table defining whether to permit a connection for each combination of a determination result based on the browser ID and a determination result based on the unique information.

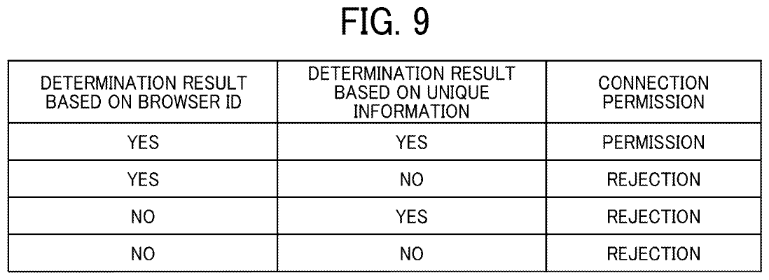

FIG. 9 illustrates an example of the connection permission determination table. In the example illustrated in FIG. 9, the remote desktop connection is permitted for a combination of the determination result based on the browser ID indicating “YES”, which means a match, and the determination result based on the unique information indicating “YES”, which means a match, and the remote desktop connection is rejected otherwise. That is, if any one of the determination results indicates “NO”, which means no match, the remote desktop connection is rejected. The connection permission determination table illustrated in FIG. 9 is an example. In another example, a remote desktop connection may be permitted when any one of the determination result based on the browser ID and the determination result based on the unique information indicates “YES”, which means a match.

The communication system according to the second embodiment is configured to determine whether to permit a remote desktop connection to a user terminal, based on a combination of a determination result based on a browser ID and a determination result based on unique information of the user terminal. Registration of only unique information related to a user terminal authorized by the administrator in advance enables only the authorized user terminal to establish a remote desktop connection. The use of hardware unique information prevents a malicious device from pretending to be the user terminal to establish a remote desktop connection. The use of a hash value as the unique information prevents leakage of information such as the hardware configuration from the registered unique information.

### Third Embodiment

The communication system according to the first embodiment is configured to permit a remote desktop connection to only a user terminal from which the previous access to the remote desktop connection via the office network is recorded, based on a browser ID that uniquely identifies the user terminal. A communication system according to a third embodiment is configured to permit a remote desktop connection to only a user terminal managed by a device management system.

The following describes a communication system 1 according to the third embodiment of the present disclosure, focusing on the differences from the first embodiment.

### General Arrangement of Communication System According to Third Embodiment

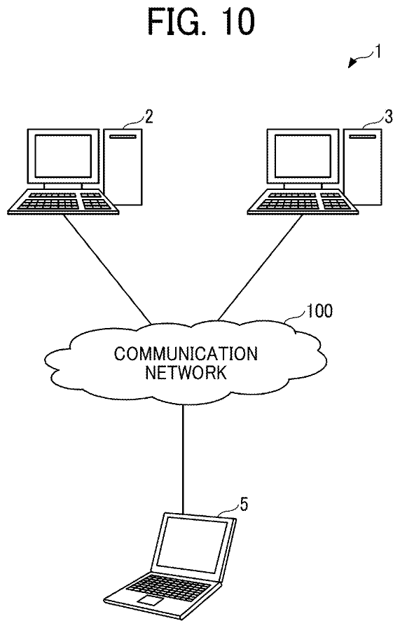

FIG. 10 is a diagram illustrating an example general arrangement of the communication system 1 according to the third embodiment of the present disclosure. As illustrated in FIG. 10, the communication system 1 according to the third embodiment includes a communication server 2, a device management server 3, and a user terminal 5, for example. The device management server 3 is connected to a communication network 100 and is capable of mutually communicating with the communication server 2 and the user terminal 5.

The device management server 3 is a computer, for example. The device management server 3 is not limited to a computer and may be any apparatus having a communication function. Examples of the device management server 3 include, but are not limited to, an output device such as a projector (PJ), an interactive whiteboard (IWB), which is an electronic whiteboard having mutual communication capability, and a digital signage, a head-up display (HUD) device, an industrial machine, an imaging device, a sound collecting device, a medical device, a networked home appliance, an automobile (connected car), a laptop PC, a mobile phone, a smartphone, a tablet terminal, a game console, a personal digital assistant (PDA), a digital camera, a wearable PC, and a desktop PC.

### Functional Configuration of Communication System According to Third Embodiment

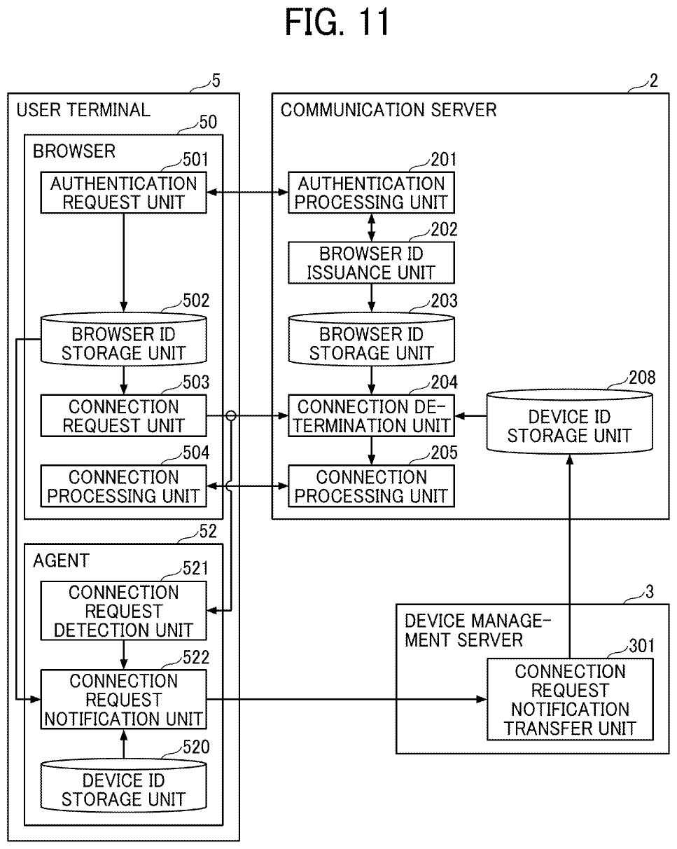

FIG. 11 is a diagram illustrating an example functional configuration of the communication system 1 according to the third embodiment.

### Functional Configuration of Communication Server

As illustrated in FIG. 11 the communication server 2 according to the third embodiment includes an authentication processing unit 201, a browser ID issuance unit 202, a browser ID storage unit 203, a connection determination unit 204, and a connection processing unit 205, as in the first embodiment, and further includes a device ID storage unit 208.

The device ID storage unit 208 stores a browser ID and a device ID, which are included in a connection request notification signal received from the device management server 3, in association with each other.

### Functional Configuration of User Terminal

As illustrated in FIG. 11, the user terminal 5 according to the third embodiment includes a browser 50, as in the first embodiment, and further includes an agent 52. The agent 52 includes a device ID storage unit 520, a connection request detection unit 521, and a connection request notification unit 522.

The device ID storage unit 520 stores a device ID that uniquely identifies the user terminal 5. The device ID is issued to the user terminal 5 in advance by the device management server 3 and is stored in the device ID storage unit 520.

The connection request detection unit 521 detects transmission of a connection request signal from the connection request unit 503 to the communication server 2.

The connection request notification unit 522 transmits a connection request notification signal to the device management server 3 to notify the device management server 3 that the connection request detection unit 521 has detected the connection request signal. The connection request notification signal includes the browser ID stored in the browser ID storage unit 502 and the device ID stored in the device ID storage unit 520.

Functional Configuration of Device Management Server

As illustrated in FIG. 11, the device management server 3 according to the third embodiment includes a connection request notification transfer unit 301.

The connection request notification transfer unit 301 of the device management server 3 is a function implemented or a means caused to function in response to the CPU 101 illustrated in FIG. 2 executing various instructions on data read into the RAM 103 in accordance with a program loaded onto the RAM 103 from the HD 104.

The connection request notification transfer unit 301 transfers a connection request notification signal received from the user terminal 5 to the communication server 2.

### Processing Procedure of Communication System According to Third Embodiment

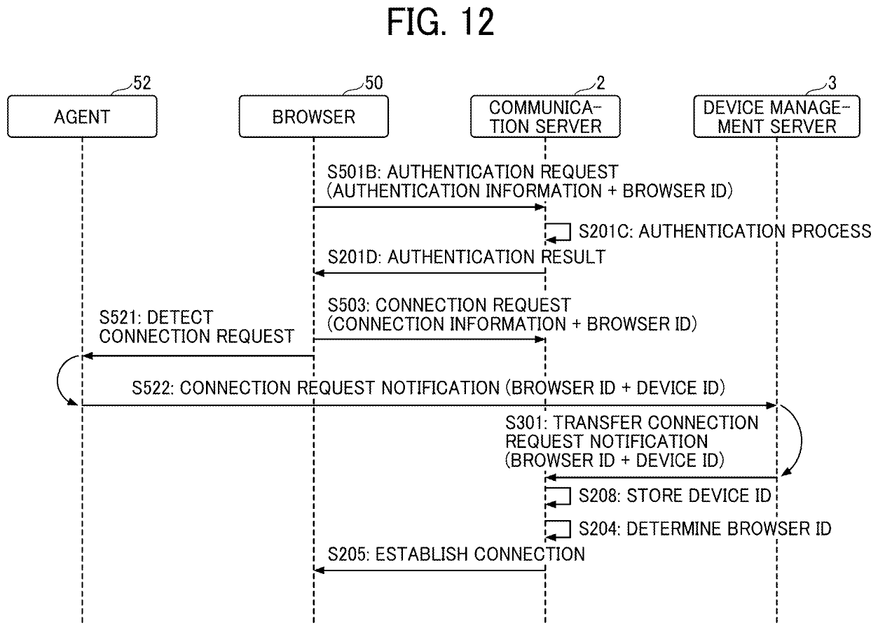

FIG. 12 is a diagram illustrating an example procedure of a communication method executed by the communication system 1 according to the third embodiment. In the illustrated procedure, as in the second embodiment, the communication server 2 has issued a browser ID to the user terminal 5.

In step S503, the connection request unit 503 of the browser 50 transmits a connection request signal to the communication server 2 in accordance with an operation performed by the user of the user terminal 5. The connection request signal includes connection information entered by the user and the browser ID stored in the browser ID storage unit 502.

In step S521, the connection request detection unit 521 of the agent 52 detects transmission of the connection request signal from the connection request unit 503 to the communication server 2. The connection request signal is transmitted in response to the browser 50 issuing a request for a URL for establishing a remote desktop connection. The URL for establishing a remote desktop connection from the device management server 3 to the agent 52 is set in the agent 52 in advance. Through monitoring transmission of a signal for requesting the URL, a connection request can be detected.

In step S522, the connection request notification unit 522 of the agent 52 transmits a connection request notification signal to the device management server 3 to notify the device management server 3 that the connection request detection unit 521 has detected the connection request signal. The connection request notification signal includes the browser ID stored in the browser ID storage unit 502 and the device ID stored in the device ID storage unit 520.

In step S301, the connection request notification transfer unit 301 of the device management server 3 receives the connection request notification signal from the user terminal 5. The connection request notification transfer unit 301 transfers the connection request notification signal received from the user terminal 5 to the communication server 2.

In step S208, the communication server 2 stores the browser ID and the device ID, which are included in the connection request notification signal received from the device management server 3, in the device ID storage unit 208 in association with the date and time of receipt of the connection request notification signal.

In step S204, the connection determination unit 204 of the communication server 2 receives the connection request signal from the user terminal 5. The connection determination unit 204 determines whether to permit the remote desktop connection to the user terminal 5, based on the browser ID included in the connection request signal. In the third embodiment, the connection determination unit 204 sets, as the predetermined condition, a condition that the browser ID included in the connection request signal received from the user terminal 5 and the browser ID included in the connection request notification signal received from the device management server 3 match.

To determine whether the condition described above is satisfied, the connection determination unit 204 determines whether the browser ID included in the connection request signal received from the user terminal 5 matches a browser ID stored in the device ID storage unit 208. The browser ID included in the connection request signal received from the user terminal 5 matches a browser ID stored in the device ID storage unit 208, which indicates that the browser ID and the device ID have been sent from the device management server 3. This means that the agent 52 is installed in the user terminal 5 and is managed by the device management server 3.

The connection determination unit 204 may determine whether a combination of the browser ID and the device ID that is most recently stored in the device ID storage unit 208 matches a previously stored combination of the browser ID and the device ID. A modified combination of the browser ID and the device ID potentially indicates the browser ID and/or the device ID is spoofed. In this case, the connection determination unit 204 rejects the remote desktop connection to the user terminal 5.

In one example, the communication server 2 does not include the device ID storage unit 208, and the connection determination unit 204 receives a connection request notification signal directly from the device management server 3. In this case, the connection determination unit 204 waits for receiving a connection request notification signal from the device management server 3 for a predetermined amount of time after receipt of the connection request signal from the user terminal 5. The amount of time during which the connection determination unit 204 waits for receiving a connection request notification signal is set as appropriate, and may be set to 10 seconds, for example. If the reception of a connection request notification signal has timed out, the connection determination unit 204 determines that a request for a remote desktop connection has been sent from a user terminal 5 in which the agent 52 is not installed, and rejects the remote desktop connection.

The communication system according to the third embodiment is configured to permit a remote desktop connection to a user terminal in response to a match being found between a browser ID included in a connection request signal received from the user terminal and a browser ID included in a connection request notification signal received from a device management server. Receipt of a browser ID from the device management server indicates that a user terminal requesting a remote desktop connection has an agent installed therein and is managed by the device management server. Accordingly, the communication system according to the third embodiment enables only user terminals managed by the device management server to establish a remote desktop connection.

Further, the communication system according to the third embodiment determines whether a browser ID included in a connection request signal received from a user terminal and a browser ID included in a connection request notification signal received from the device management server match. The communication system according to the third embodiment further determines whether a combination of the browser ID and the device ID included in the connection request notification signal is not modified from that which has been previously received. This prevents spoofing in which an attacker tries to establish a remote desktop connection using a spoofed browser ID or device ID.

### Fourth Embodiment

The communication system according to the first embodiment issues a browser ID such that a user terminal can be uniquely identified, and determines whether to permit a remote desktop connection, based on the browser ID. A communication system according to a fourth embodiment further includes a relay device to be connected to a predetermined network, issues a certificate to only a user terminal permitted to communicate with the relay device, and determines whether to permit a remote desktop connection, based on the certificate.

The following describes a communication system 1 according to the fourth embodiment of the present disclosure, focusing on the differences from the first embodiment.

### General Arrangement of Communication System According to Fourth Embodiment

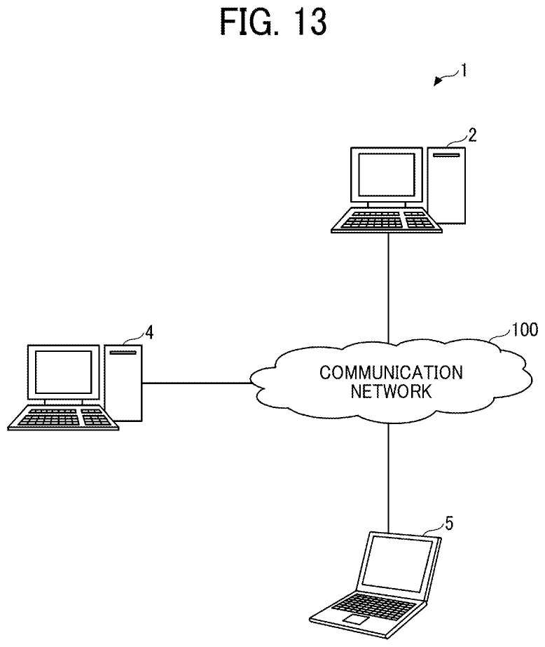

FIG. 13 is a diagram illustrating an example general arrangement of the communication system 1 according to the fourth embodiment of the present disclosure. As illustrated in FIG. 13, the communication system 1 according to the fourth embodiment includes a communication server 2, a relay device 4, and a user terminal 5, for example. The relay device 4 is connected to a communication network 100 and is capable of mutually communicating with at least the communication server 2.

The relay device 4 is a computer, for example. The relay device 4 is not limited to a computer and may be any apparatus having a communication function. Examples of the relay device 4 include, but are not limited to, an output device such as a projector (PJ), an interactive whiteboard (IWB), which is an electronic whiteboard having mutual communication capability, and a digital signage, a head-up display (HUD) device, an industrial machine, an imaging device, a sound collecting device, a medical device, a networked home appliance, an automobile (connected car), a laptop PC, a mobile phone, a smartphone, a tablet terminal, a game console, a personal digital assistant (PDA), a digital camera, a wearable PC, and a desktop PC.

### Functional Configuration of Communication System According to Fourth Embodiment

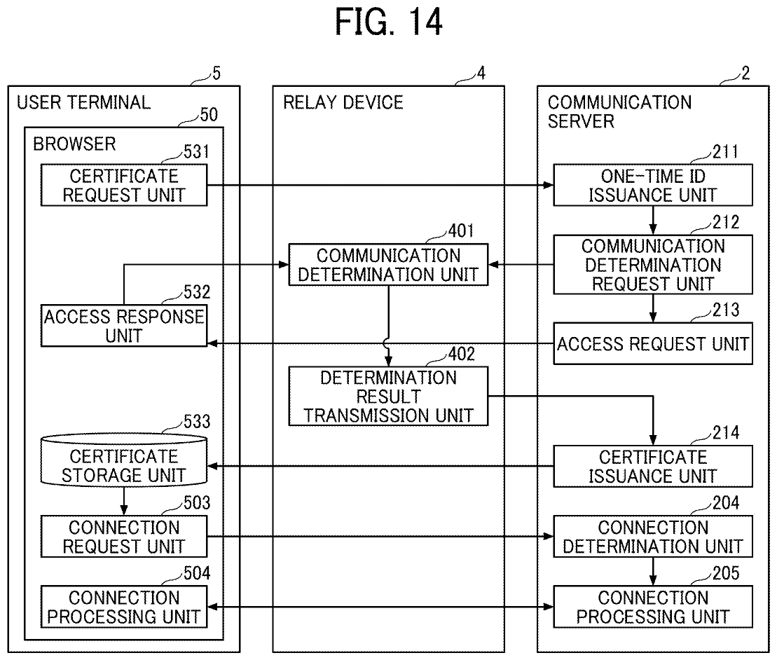

FIG. 14 is a diagram illustrating an example functional configuration of the communication system 1 according to the fourth embodiment.

### Functional Configuration of Communication Server

As illustrated in FIG. 14, the communication server 2 according to the fourth embodiment includes a connection determination unit 204 and a connection processing unit 205, as in the first embodiment, and further includes a one-time ID issuance unit 211, a communication determination request unit 212, an access request unit 213, and a certificate issuance unit 214.

The one-time ID issuance unit 211 receives a signal for requesting a certificate from the user terminal 5. The signal is hereinafter referred to as “certificate request signal”. The one-time ID issuance unit 211 issues a one-time ID. The one-time ID is used to determine whether communication is permitted between the relay device 4 and the user terminal 5.

The communication determination request unit 212 transmits a signal for requesting determination of whether communication with the user terminal 5 is permitted to the relay device 4. The signal is hereinafter referred to as “communication permission determination request signal”. The communication permission determination request signal includes the one-time ID issued by the one-time ID issuance unit 211.

The access request unit 213 transmits a signal for requesting access to the relay device 4 to the user terminal 5. The signal is hereinafter referred to as “access request signal”. The access request signal includes the one-time ID issued by the one-time ID issuance unit 211.

The certificate issuance unit 214 receives, from the relay device 4, a result of the determination of whether communication with the user terminal 5 is permitted. The result is hereinafter referred to as “communication permission determination result”. The certificate issuance unit 214 issues a certificate to the user terminal 5 permitted to communicate with the relay device 4. The certificate issuance unit 214 transmits the issued certificate to the user terminal 5.

### Functional Configuration of Relay Device

As illustrated in FIG. 14, the relay device 4 according to the fourth embodiment includes a communication determination unit 401 and a determination result transmission unit 402.

The communication determination unit 401 and the determination result transmission unit 402 of the relay device 4 are functions implemented or means caused to function in response to the CPU 101 illustrated in FIG. 2 executing various instructions on data read into the RAM 103 in accordance with a program loaded onto the RAM 103 from the HD 104.

The communication determination unit 401 receives the communication permission determination request signal from the communication server 2. The communication determination unit 401 determines whether communication with the user terminal 5 is permitted by using the one-time ID included in the communication permission determination request signal.

The determination result transmission unit 402 transmits the communication permission determination result obtained by the communication determination unit 401 to the communication server 2.

### Functional Configuration of User Terminal

As illustrated in FIG. 14, the user terminal 5 according to the fourth embodiment includes a browser 50, as in the first embodiment. The browser 50 according to the fourth embodiment includes a connection request unit 503 and a connection processing unit 504, as in the first embodiment, and further includes a certificate request unit 531, an access response unit 532, and a certificate storage unit 533.

The certificate request unit 531 transmits the certificate request signal to the communication server 2 in accordance with an operation performed by the user of the user terminal 5.

The access response unit 532 receives the access request signal from the communication server 2. The access response unit 532 accesses the relay device 4 using the one-time ID included in the access request signal.

The certificate storage unit 533 stores the certificate issued by the communication server 2 to the user terminal 5.

### Processing Procedure of Communication System According to Fourth Embodiment

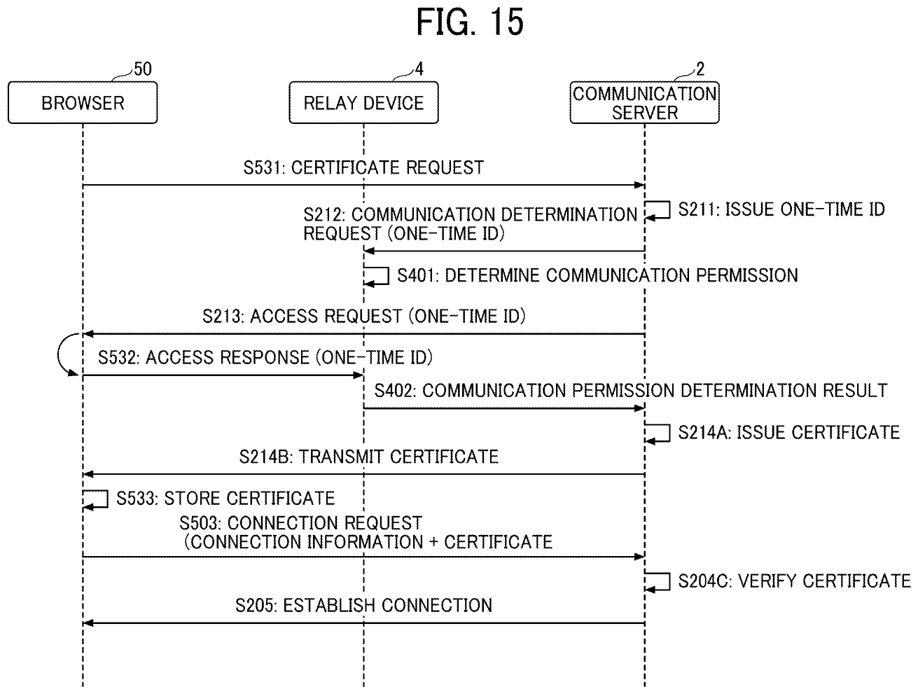

FIG. 15 is a diagram illustrating an example procedure of a communication method executed by the communication system 1 according to the fourth embodiment.

In step S531, the certificate request unit 531 of the browser 50 transmits a certificate request signal to the communication server 2 in accordance with an operation performed by the user of the user terminal 5.

In step S211, the one-time ID issuance unit 211 of the communication server 2 receives the certificate request signal from the user terminal 5. The one-time ID issuance unit 211 issues a one-time ID to be used to determine whether communication with the user terminal 5 is permitted.

In step S212, the communication determination request unit 212 of the communication server 2 transmits a communication permission determination request signal to the relay device 4. The communication permission determination request signal includes the one-time ID issued by the one-time ID issuance unit 211.

In step S401, the communication determination unit 401 of the relay device 4 receives the communication permission determination request signal from the communication server 2. The communication determination unit 401 waits for access to be made using the one-time ID included in the communication permission determination request signal for a predetermined amount of time. The amount of time during which the communication determination unit 401 waits for access to be made using the one-time ID is set as appropriate, and may be set to 10 seconds, for example.

If access is made using the one-time ID within the predetermined amount of time, the communication determination unit 401 determines that communication with the user terminal 5 is permitted. By contrast, if no access is made using the one-time ID within the predetermined amount of time, the communication determination unit 401 determines that communication with the user terminal 5 is not permitted. Even when access is made using the one-time ID within the predetermined amount of time, the communication determination unit 401 determines that communication with the user terminal 5 is not permitted if the one-time ID used for the access is different from the one-time ID received from the communication server 2.

In step S213, the access request unit 213 of the communication server 2 transmits an access request signal to the user terminal 5. The access request signal includes the one-time ID issued by the one-time ID issuance unit 211.

In step S532, the access response unit 532 of the browser 50 receives the access request signal from the communication server 2. The access response unit 532 accesses the relay device 4 using the one-time ID included in the access request signal. The relay device 4 is accessed in response to, for example, the browser 50 requesting a URL for determining whether to permit communication. In this case, the one-time ID is provided as, for example, a query parameter for accessing the URL.

In step S402, the determination result transmission unit 402 of the relay device 4 transmits a communication permission determination result to the communication server 2. The communication permission determination result is obtained by the communication determination unit 401 determining whether communication with the user terminal 5 is permitted.

In step S214A, the certificate issuance unit 214 of the communication server 2 receives the communication permission determination result from the relay device 4. If the communication permission determination result indicates that communication with the user terminal 5 is permitted, the certificate issuance unit 214 issues a certificate to the user terminal 5. If the communication permission determination result indicates that communication with the user terminal 5 is not permitted, the certificate issuance unit 214 transmits an error screen indicating rejection of the issuance of a certificate to the user terminal 5.

In step S214B, the certificate issuance unit 214 of the communication server 2 transmits the issued certificate to the user terminal 5.

In step S533, the certificate request unit 531 of the browser 50 receives the certificate from the communication server 2. The certificate request unit 531 stores the received certificate in the certificate storage unit 533. The certificate is stored in the browser by using a typical function of the browser. If the OS installed in the user terminal 5 has a function of managing the certificate, the certificate may be stored in the OS.

In step S503, the connection request unit 503 of the browser 50 transmits a connection request signal to the communication server 2 in accordance with an operation performed by the user of the user terminal 5. In the fourth embodiment, the connection request signal includes the connection information entered by the user and the certificate stored in the certificate storage unit 533.

In step S204C, the connection determination unit 204 of the communication server 2 receives the connection request signal from the user terminal 5. The connection determination unit 204 determines whether to permit a remote desktop connection to the user terminal 5, based on the certificate included in the connection request signal. For example, the connection determination unit 204 verifies the certificate received from the user terminal 5 and permits the remote desktop connection to the user terminal 5 if the received certificate is valid. By contrast, if the certificate received from the user terminal 5 is invalid, the connection determination unit 204 rejects the remote desktop connection to the user terminal 5.

The communication system according to the fourth embodiment is configured to issue a certificate only to a user terminal permitted to connect to a relay device. For example, the relay device is connected to an office network. In this case, a certificate is issuable only to a user terminal accessing the office network via which communication with the relay device is permitted. The certificate is used to determine whether to permit a remote desktop connection, which enables only a user terminal accessing the office network to establish a remote desktop connection.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The apparatuses or devices described in the embodiments are just one example of a plurality of computing environments that implement the embodiments disclosed herein. In some embodiments, the communication server 2 includes a plurality of computing devices, such as a server cluster. The plurality of computing devices are configured to communicate with one another through any type of communication link including a network, shared memory, etc., and perform the processes disclosed herein.

In the embodiments described above, the browser ID is an example of identification information. The browser ID issuance unit 202 is an example of an identification information issuance unit.

1. A communication system comprising:
a user terminal; and
a communication server,
the user terminal including first circuitry configured to:
request the communication server to perform authentication; and
transmit identification information for identifying the user terminal to the communication server to request the communication server to establish a connection, the identification information being issued by the communication server in response to the user terminal having been successfully authenticated,
the communication server including second circuitry configured to:
issue the identification information in response to a result of the authentication indicating successful authentication; and
determine whether to permit a connection to the user terminal, based on the identification information received from the user terminal.

2. The communication system according to claim 1,
wherein the second circuitry of the communication server is configured to permit the connection to the user terminal in response to the identification information received from the user terminal indicating that the user terminal has previously established the connection from a predetermined network.

3. The communication system according to claim 2,
wherein the identification information is associated with user information related to the user terminal, and
wherein the second circuitry of the communication server is configured to issue the identification information such that the identification information and the user information related to the user terminal that has been successfully authenticated are associated with each other on a one-to-one basis.

4. The communication system according to claim 1,
wherein the first circuitry of the user terminal is configured to transmit unique information related to hardware of the user terminal in addition to the identification information to the communication server to request the communication server to establish the connection, and
wherein the second circuitry of the communication server is configured to determine whether to permit the connection, based on a determination result based on the identification information received from the user terminal and a determination result based on the unique information received from the user terminal.

5. The communication system according to claim 4,
wherein the unique information includes a hash value obtained by inputting attribute information acquired from the hardware of the user terminal to a hash function.

6. The communication system according to claim 4,
wherein the unique information includes a plurality of pieces of attribute information acquired from the hardware of the user terminal, and
wherein the second circuitry of the communication server is configured to compare the unique information received from the user terminal with unique information related to the hardware of the user terminal and registered in advance and determine whether to permit the connection, based on a number of pieces of attribute information for which a match is found between the received unique information and the registered unique information.

7. The communication system according to claim 1,
wherein the first circuitry of the user terminal is configured to send the identification information to a device management server in response to detection of a request for the connection, and
wherein the second circuitry of the communication server is configured to permit the connection in response to a match between the identification information received from the user terminal and the identification information sent from the device management server.

8. The communication system according to claim 7, further comprising:
a device management server configured to transfer the identification information received from the user terminal to the communication server.

9. A communication system comprising:
a user terminal;
a relay device including circuitry configured to
determine whether the relay device and the user terminal are communicable; and
a communication server,
the user terminal including circuitry configured to:
request the communication server to issue a certificate; and
transmit the certificate to the communication server to request the communication server to establish a connection, the certificate being issued by the communication server in response to a determination indicating that the relay device and the user terminal are communicable,
the communication server including circuitry configured to:
issue the certificate in accordance with a result of the determination by the circuitry of the relay device; and
determine whether to permit the connection, based on the certificate received from the user terminal.

10. A communication control method comprising:
obtaining an authentication result in response to a request from a user terminal;
issuing identification information for identifying the user terminal in response to the authentication result indicating successful authentication; and
determining whether to permit a connection to the user terminal, based on the identification information received from the user terminal.

11. A non-transitory recording medium storing a plurality of instructions which, when executed by one or more processors, cause the processors to perform a communication control method comprising:
obtaining an authentication result in response to a request from a user terminal;
issuing identification information for identifying the user terminal in response to the authentication result indicating successful authentication; and
determining whether to permit a connection to the user terminal, based on the identification information received from the user terminal.
